(19) United States
(12) Patent Application Publication
(10) Pub. No.: US 2020/0134398 A1
(43) Pub. Date: Apr. 30, 2020

(54) DETERMINING INTENT FROM MULTIMODAL CONTENT EMBEDDED IN A COMMON GEOMETRIC SPACE

(71) Applicant: SRI International, Menlo Park, CA (US)

(72) Inventors: Julia Kruk, Rego Park, NY (US); Jonah M. Lubin, Palmer Square, NJ (US); Karan Sikka, Lawrenceville, NJ (US); Xiao Lin, Princeton, NJ (US); Ajay Divakaran, Monmouth Junction, NJ (US)

(21) Appl. No.: 16/383,437

(22) Filed: Apr. 12, 2019

Related U.S. Application Data
(60) Provisional application No. 62/752,192, filed on Oct. 29, 2018.

(51) Int. Cl. G06K 9/62; G06N 20/20; G06Q 50/00

(52) U.S. Cl. CPC G06K 9/6292; G06Q 50/01; G06N 20/20

(57) ABSTRACT

Inferring multimodal content intent in a common geometric space in order to improve recognition of influential impacts of content includes mapping the multimodal content in a common geometric space by embedding a multimodal feature vector representing a first modality of the multimodal content and a second modality of the multimodal content and inferring intent of the multimodal content mapped into the common geometric space such that connections between multimodal content result in an improvement in recognition of the influential impact of the multimodal content.

### CROSS-REFERENCE TO RELATED APPLICATIONS

This application claims priority to and the benefit of U.S. Provisional Patent Application Ser. No. 62/752,192, filed Oct. 29, 2018 which is incorporated herein by this reference in their entirety.

### GOVERNMENT RIGHTS

This invention was made with government support under contract number N00014-17-C-1008 awarded by the Office of Naval Research. The Government has certain rights in this invention.

### BACKGROUND

Social media has become ubiquitous over the last 10 years. Some may even say it has become part of the fabric of modern society. Anyone can now express their views online without having to be a professional or without needing expensive broadcasting equipment, making it possible for people to express their opinions at any time or any place without censorship. With the freedom to express oneself, a person may often express their true intent through a collage of different forms of communication means such as text, images, videos, and audio. Because a combination of more than one modality is often used, the intent of posted information may be lost or obscured. In some cases, users of social media may intentionally obscure the meaning so that only a select group of users fully understand their intentions. Other users may post information with the hope of causing a certain response, but instead receive a completely different response.

Determining the intent of a given social media post is not only useful in evaluating advertising effectiveness, but also in aiding law enforcement by notifying them of threatening behavior. However, determining the true intent of social media postings becomes even more difficult when users use different combinations of the multitude of modalities at their disposal.

### SUMMARY

Embodiments of the present principles generally relate to determining intent from multimodal content embedded in a common geometric space.

In some embodiments, a method of creating a semantic embedding space for multimodal content for determining intent of content comprises for each of a plurality of content of the multimodal content, creating a respective, first modality feature vector representative of content of the multimodal content having a first modality using a first machine learning model; for each of a plurality of content of the multimodal content, creating a respective, second modality feature vector representative of content of the multimodal content having a second modality using a second machine learning model; for each of a plurality of first modality feature vector and second modality feature vector multimodal content pairs, forming a combined multimodal feature vector from the first modality feature vector and the second modality feature vector; for at least one first modality feature vector and second modality feature vector multimodal content pair, assigning at least one taxonomy class of intent; and semantically embedding the respective, combined multimodal feature vectors in a common geometric space, wherein embedded combined multimodal feature vectors having related intent are closer together in the common geometric space than unrelated multimodal feature vectors.

In some embodiments, the method may further include wherein semantically embedding multimodal content into the common geometric space comprises: projecting a multimodal feature vector representing a first modality feature of the multimodal content and a second modality feature of the multimodal content into the common geometric space and inferring an intent of the multimodal content mapped into the common geometric space based on a proximity of the mapped multimodal content to at least one other mapped multimodal content in the common geometric space having a predetermined intent such that determined related intents between multimodal content result in an improvement in recognition of influential impact of the multimodal content; wherein the multimodal content is a social media posting; determining if a first multimodal content is in proximity to a desired intent; suggesting alterations of the first multimodal content such that the altered first multimodal content, if mapped to the common geometric space, would be closer to the desired intent; wherein intent is classified by a taxonomy comprising advocative, information, expressive, provocative, entertainment, and exhibitionist classes; determining a contextual relationship between a first modality feature represented by the first modality feature vector of the multimodal content and a second modality feature represented by the second modality feature vector of the multimodal content; wherein the contextual relationship is classified by a taxonomy comprising minimal, close, and transcendent classes; inferring a semiotic relationship between a first modality represented by the first modality feature vector of the multimodal content and a second modality represented by the second modality feature vector of the multimodal content; wherein the semiotic relationship is classified by a taxonomy comprising divergent, parallel, and additive classes; wherein the common geometric space is a non-Euclidean common geometric space; and/or semantically embedding the respective, combined multimodal feature vectors including the respective at least one taxonomy class of intent in a common geometric space.

In some embodiments, a method of creating a semantic embedding space for multimodal content for determining intent of content, the method may comprise for each of a plurality of content of the multimodal content, creating a respective, first modality feature vector representative of content of the multimodal content having a first modality using a first machine learning model; for each of a plurality of content of the multimodal content, creating a respective, second modality feature vector representative of content of the multimodal content having a second modality using a second machine learning model; for each of a plurality of first modality feature vector and second modality feature vector multimodal content pairs, forming a combined multimodal feature vector from the first modality feature vector and the second modality feature vector; for at least one first modality feature vector and second modality feature vector multimodal content pair, assigning at least one taxonomy class of intent; projecting the combined multimodal feature vector into the common geometric space; and inferring an intent of the multimodal content represented by the combined multimodal feature vector based on the projection of the multimodal feature vector in the common geometric space and a classifier.

In some embodiments, the method may further include determining if a first multimodal content associated with a first agent is in proximity to a desired intent and suggesting alterations of the first multimodal content to the first agent such that the first multimodal content will be mapped into the common geometric space closer to the desired intent; inferring a semiotic relationship between a first modality represented by the first modality feature vector of the multimodal content and a second modality represented by the second modality feature vector of the multimodal content; and/or wherein intent is classified by the classifier based on a taxonomy comprising advocative, information, expressive, provocative, entertainment, and exhibitionist classes.

In some embodiments, non-transitory computer-readable medium having stored thereon at least one program, the at least one program including instructions which, when executed by a processor, cause the processor to perform a method of creating a semantic embedding space for multimodal content for determining intent of content may comprise for each of a plurality of content of the multimodal content, creating a respective, first modality feature vector representative of content of the multimodal content having a first modality using a first machine learning model; for each of a plurality of content of the multimodal content, creating a respective, second modality feature vector representative of content of the multimodal content having a second modality using a second machine learning model; for each of a plurality of first modality feature vector and second modality feature vector multimodal content pairs, forming a combined multimodal feature vector from the first modality feature vector and the second modality feature vector; for at least one first modality feature vector and second modality feature vector multimodal content pair, assigning at least one taxonomy class of intent; and semantically embedding the respective, combined multimodal feature vectors in a common geometric space, wherein embedded combined multimodal feature vectors having related intent are closer together in the common geometric space than unrelated multimodal feature vectors.

In some embodiments, the non-transitory computer-readable medium may include determining if a first multimodal content associated with a first agent is in proximity to a desired intent and suggesting alterations of the first multimodal content to the first agent such that the first multimodal content will be mapped into the common geometric space closer to the desired intent; inferring a semiotic relationship between a first modality represented by the first modality feature vector of the multimodal content and a second modality represented by the second modality feature vector of the multimodal content; and/or wherein the semiotic relationship is classified by a taxonomy comprising divergent, parallel, and additive classes.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 is a method for determining intent of multimodal content in accordance with an embodiment of the present principles.

FIG. 2 illustrates three taxonomies in accordance with an embodiment of the present principles.

FIG. 3 shows a distribution of classes across three taxonomies in accordance with an embodiment of the present principles.

FIG. 4 shows performance results of different models in accordance with an embodiment of the present principles.

FIG. 5 shows class-wise performances with a single modality and a multi-modality model in accordance with an embodiment of the present principles.

FIG. 6 shows a confusion matrix in accordance with an embodiment of the present principles.

FIG. 7 shows efficacy of a classification excluding examples in which a semiotic relationship between a caption and an image is divergent in accordance with an embodiment of the present principles.

FIG. 8 shows an image matched with two different captions in accordance with an embodiment of the present principles.

FIG. 9 depicts a high level block diagram of a computing device in which a multimodal content embedding and/or document intent system can be implemented in accordance with an embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for determining intent from multimodal content embedded in a common geometric space. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to visual concepts, such teachings should not be considered limiting.

The propagation of influence in social media occurs readily in a number of platforms such as Twitter, YouTube, Instagram, Reddit, Facebook, etc. In all of these platforms, the conventional method to analyze content merely provides scene analysis which is not sufficient. The intent behind the content that has been posted also needs to be accounted for. In social media, the notion of content expands beyond the conventional text-only meaning to a multimodal definition which includes text, video, audio, still images and possible other kinds of data such as outputs of smart watches and the like. For text, the intent can be gleaned through the analysis of rhetoric and communication acts. In the case of image-caption pairs, the pairing can be understood through the study of visual semiotics and semantics. This combination of images and captions yields a multiplication in meaning that goes beyond conventional notions of the complementarity of the image and text modalities. In other words, the overall meaning of the image-caption pairing is greater than the sum of the meanings of the individual image and caption respectively.

A new notion of document intent characterizes the fundamental currency of interaction in social media, namely persuasive intent. Measurement of document intent enables accurate tracking of user actions in social media, anticipation of major trends, modeling of user reaction to content and prediction of complex events in social media. It is also a fundamental advance in document understanding. A new framework utilized herein consists of a new taxonomy for document intent as well as two taxonomies for the contextual (semantic) and semiotic relationships, respectively, between an image and a caption. A novel deep learning based automatic classifier is also introduced that automatically computes the document intent and the contextual and semiotic relationships.

In one example discussed below, the system determines intent from Instagram posts. Instagram is unique in its emphasis on the visual modality and in its range of intent, semiotics and semantics among its users. Existing intent, semiotics and semantics image-caption taxonomies can be adapted to the Instagram platform to create an adapted taxonomy that consists of intent, semiotic relationship and semantic or contextual relationship. The taxonomy provided by the present principles identifies intent categories in Instagram postings that address the unique aspects of Instagram postings that are not currently addressed. The embedded framework provided below can be used to carry out classification of social media postings and the like based on intent, semiotic, and semantic categories defined by the taxonomy.

In some embodiments, a system is trained on existing intent, semiotics, and contextual (semantics) image-caption taxonomies that have been adapted for the social media platform. The system can then identify intent categories in social media postings. A machine learning based automatic classification technique may be used for training and testing. Multimodal embeddings may also be used to embed users and content (images and text) in a common geometric space enabling three-way retrieval across users-text-images. Such retrieval enables determination of user groups that are interested in a given content item as well as determination of typical items sought by a particular user group. This can be used to establish a framework for assessment of influence using multimodal content. As discussed in more detail below, the embedding mechanism may be used to generate a feature vector for each social media posting and a machine learning model or classifier is trained using those feature vectors. In some embodiments, the intent, semiotic relationship, and semantic relationship are directly embedded, into the joint embedding so that the embedding itself directly yields the position of the social media posting in the taxonomy. The present principles allow automatic techniques for determination of the intent, semiotic and semantic relationships between images, and captions in a social media posting.

The joint embedding of users' reaction, users, audio, video and text in a common geometric space enables both recognition of previously unseen events involving user reaction and content as well as a unified model to predict user reaction to content and a flexible clustering methodology. For example, if a new speech by a political leader is found, it will be possible to predict who would react positively to the leader even though that leader is seen for the first time. The technology of the present principles may also allow governments to be able to better track extremist groups through their social media postings. In addition, the commercial application of the present principles is wide ranging in terms of content reaction profiling and associated micro-targeting for product and advertisement placement and the like.

In order to determine intent of a social media post, the post is first broken down into separate modalities and processed by machine learning models trained for that particular modality. Vector representations are then constructed for the different modalities and combined into a single representative vector that is embedded into a common geometric space. Additional information may also be embedded such as a user or a group of users and a taxonomy label. The taxonomy is used to classify the postings as whole to account for meaning multiplication of the combination of different modalities. Each modality may contribute a different portion of the overall intent of the posting. To better understand how the different modalities affect the intent of a posting, the process of converting the posting for use in a machine learning model is discussed first followed by the taxonomy and then intent determination.

In some embodiments, words and images are transformed into vectors that are embedded into a common geometric space. Distance between vectors is small when vectors are semantically similar. In some embodiments, words and images may be transformed into vectors that are embedded into a non-Euclidean geometric space which preserves hierarchies. The inventors have also found that by using a model that jointly learns agent and content embedding, additional information can be extracted with regard to the original poster of the content and/or other agents who appear nearby in the embedding space. The model may also be adjusted such that agents are clustered based on their posted and/or associated content. The image-text joint embedding framework is leveraged to create content to user embeddings. Each training example is a tuple of an image and a list of users who posted the image. In some embodiments, the method learns the user embeddings and the image embeddings jointly in a single neural network. Instead of the embedding layer for words, there is an embedding layer for users. Some embodiments have a modification which allows learning of a clustering of users in addition to the user embeddings inside the same network. Learning the clusters jointly allows for a better and automatic sharing of information about similar images between user embeddings than what is available explicitly in the dataset.

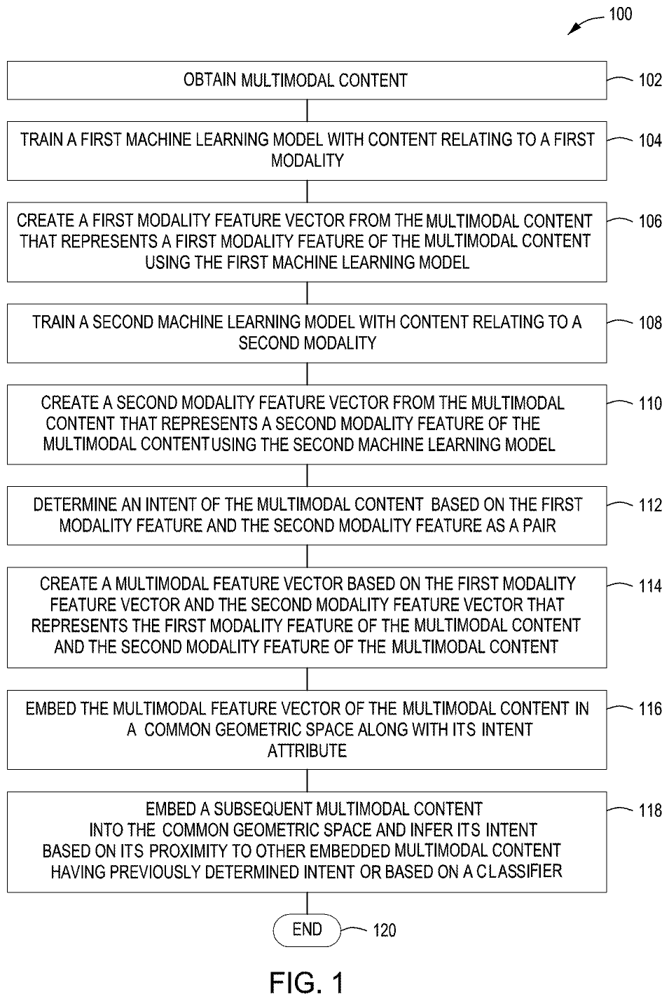

The application of methods of the present principles opens new ways to predict or infer information based on the multimodal content embedded in a common geometric space. One area of current interest is in predicting a user's intent behind multimodal content such as, but not limited to, postings on social networks such as, for example, Instagram. In FIG. 1, a method 100 for determining intent of multimodal content according to an embodiment of the present principles is illustrated. In block 102, multimodal content, such as, for example, a social media posting, is obtained. In block 104, a first machine learning model is trained with content relating to a first modality. In block 106, a first modality feature vector is created from the multimodal content that represents a first modality feature of the multimodal content using the first machine learning model. In block 108, a second machine learning model is trained with content relating to a second modality. In block 110, a second modality feature vector is created from the multimodal content that represents a second modality feature of the multimodal content using the second machine learning model. In block 112, an intent of the multimodal content is determined based on the first modality feature and the second modality feature as a pair. At least one taxonomy class of intent is then assigned to the multimodal content pair. In some embodiments, the intent determination and classification assignment may be accomplished by human and/or non-human (e.g., machine) entities trained on intent taxonomy described below. In block 114, a multimodal feature vector is created based on the first modality feature vector and the second modality feature vector that represents the first modality feature of the multimodal content and the second modality feature of the multimodal content.

In block 116, the multimodal feature vector of the multimodal content is embedded into a common geometric space along with its intent attribute. In some embodiments, the intent may be combined into the multimodal feature vector that is embedded into the common geometric space rather than attaching the intent as an attribute to the multimodal feature vector. In block 118, a subsequent multimodal content is processed by the machine learning models and its multimodal feature vector is embedded into the common geometric space. Its intent is inferred by its proximity to other embedded multimodal content that have previously determined intent or based on a classifier, ending the flow 120. In some embodiments, a multimodal feature vector may have its intent inferred by linearly projecting each of the first and second modality feature vectors into a common geometric space and then adding the first and second modality feature vectors to yield a multimodal feature vector (“fused vector”). The multimodal feature vector may have its intent determined by using a classifier rather than by proximity of other multimodal vectors in the common geometric space.

In some embodiments, the method 100 may be adjusted to embed other information such as, for example, user reactions to social media postings and enable inference of reactions to subsequent social media postings. The joint embedding of users' reactions, users, audio, video, and text (i.e., multimodal content) in a common space enables both recognition of previously unseen events involving user reaction and content as well as a unified model to predict user reaction to content and a flexible clustering methodology. For example, if a new speech by a political leader comes up, it is possible to predict who would react positively to the leader even though that leader might be seen for the first time. This may also allow governments and protective agencies to better track extremist groups with such technology. In addition, the commercial application is wide ranging in terms of content reaction profiling and associated micro-targeting for product and advertisement placement.

The notion of document intent in Instagram posts is introduced herein. That is, data which is primarily visual, but usually includes captions which makes them inherently multimodal. The inventors have observed that the meaning of an Instagram post is the result of meaning multiplication between the image and the caption. Thus, neither the caption nor the image is a mere transcript of the other, but, in fact, combine to create a meaning that is more than the sum of the semiotic analysis of the caption and image conducted separately. Since Instagram is a social medium, there is a persuasive intent behind every post. The inventors have discovered that the relationship between the image and the caption is key to understanding the underlying intent of Instagram media. The inventors have also found two key aspects of that relationship, first the contextual, which captures the overlap in the meaning of the image and caption, and second the semiotic, since both the image and the caption can signify concepts.

The inventors have created a taxonomy of intent-semiotic relationships and contextual relationships based on the analysis of a large variety of Instagram posts. In one example, a dataset of 1299 Instagram posts is introduced and annotated using this taxonomy. A baseline deep learning based multimodal method is then shown to validate the taxonomy. The results demonstrate that there is an increase of at least approximately 8% in detection of intent when multimodal inputs are used rather than just by images alone. The quantitative results support that there is meaning multiplication through the combination of the image and its caption.

With the advent of social media platforms, an individual no longer needs to be a professional in order to create and propagate informative media, promote ideas, and, thus, influence people with the advent of social media platforms such as Instagram, Facebook, and Twitter. Each piece of content posted by a social media user has a certain intent (referred to as ‘document intent’) behind it that determines the nature of the influence it has. For example an informative post intends to inform, while an opinionated post intends to both express and influence opinion. The overall propagation of influence in social media is determined by the interaction of the intents behind the posts. To fully understand the propagation of influence in social media, the document intent of social media posts has become as important as that of official news sources in the study of the flow of information.

However, the document intent of informal media cannot be analyzed in the same manner as documents have been analyzed in the past because certain formalities in structure and language are no longer adhered to on social platforms. In addition, the abundant use of social media has ushered in an age of visual literacy, where the general public is frequently making use of visual rhetoric in day to day informal communication. In the case of platforms such as Instagram, meaning and intention no longer rest solely on the written word, but on the confluence of visual and semantic rhetoric used simultaneously. In other words, the text and image are not subservient to each other. They instead have an equal role in creating the overall meaning of the Instagram post, and subtle changes to either caption or images can change the intended meaning of the post completely.

The way a post on Instagram creates meaning through the combination of text and image has not been sufficiently explored in the past. This is partly because Instagram-like communication through non-professionally created image-caption pairs is a newer concept and, thus, not fully understood phenomenon. Past approaches to captioning images have focused on professionally created content such as advertisements or chapters-articles in which the image-caption pair supports a larger piece of text. Until now, the study of image-text pairs has, thus, been asymmetrical, regarding either the image or text as the primary content, with the other being used only as the complement. Semantic rhetoric and visual rhetoric have been studied independently, however, the semiotics, i.e., what the content signifies or symbolizes, of visual-text content (or image-caption pairs) cannot be understood by the simple linear addition of the semiotics of its two independent modalities. In fact, the semiotics of such multimodal data is a meaning multiplication of the two modalities. Thus, the inventors have found that a new conception of the visual/textual unit is necessary in order to understand how Instagram posts create meaning, and, ultimately, how a machine learning model may be able to classify this meaning. To achieve this, the understanding of how visual and textual content work together must be significantly modified.

Multimodality is usually understood in terms of parallel data. That is to say, different types of data all from the same source combine in parallel to provide a better understanding of that source. This sort of parallel combination can be useful, but the inventors have found that a much different mechanism is at work within Instagram posts and other similarly constituted social media. The inventors found that there is a non-linear relationship between the semiotic distance of the visual and textual content and the ability of a machine learning model to determine intent. The machine learning models of the present principles leverage meaning multiplication, wherein meaning is not created by summing the information from text and image, then adding cues when necessary, but rather by text and image combining to create a totally new meaning based on the information they present. The inventors have discovered meaning multiplication through a formulation of the semiotic relationship between the image and the associated caption. Embodiments of the present principles are not bounded to a single form of media, and focus on the many forms of intent evidenced in “free-form” content such as Instagram posts, as opposed to focusing on the reaction of an audience.

Part of what makes Instagram and other social media unique is that the caption is not necessarily subordinate to the image, nor is the opposite true. The inventors have found that what is important is the symmetric relationship between the two, not one's relationship to the other. Thus, a contextual taxonomy used by the present principles has three classifications—Minimal Relationship, Close Relationship, and Transcendent Relationship. The contextual taxonomy classifies the contextual relationship between the image and caption. A second taxonomy is used to classify the semiotic relationship between the two modalities based to complete the classification schema. Semiotics seeks to find and describe the significance of signs. This semiotic taxonomy is used along with the above contextual taxonomy to describe all possible formal elements of an Instagram post that could be used to determine intent. The above contextual classifications properly describe the meaning inherent to the image and text, and the semiotic categories allow for classifications of the signs themselves. The semiotic relationship of image/text pairs can be classified as divergent, parallel, or additive. In some embodiments, the taxonomy, contextual and/or semiotic, may be an attribute to multimodal content embedded in a common space and/or may be co-embedded with the multimodal content in the common space.

A divergent relationship occurs when the image and text semiotics pull in opposite directions, creating a gap between the meaning suggested by the image and the meaning suggested by the text. A parallel relationship occurs when the image and text work toward the same meaning but make their own contributions independently. An additive relationship occurs when the image semiotics and text semiotics depend on each other, either amplifying or modifying a meaning that is greater than what can be understood by just taking in the image and text at face-value. This semiotic classification is not always parallel to the contextual one. For example, a post from a newspaper like the New York Times can show an image of a car accident that occurred in Manhattan and the caption will describe the event, the potential causes, and effects. The contextual relationship will be a “Transcendent Relationship” because the image/text unit paints a bigger story than either image or text could have on its own. However, the semiotic relationship is “Parallel.” For this reason, both of these classifications are used in the manual labeling of the Instagram dataset.

In addition, an intent taxonomy is utilized which separates intent into seven labels: advocative, promotive, exhibitionist, provocative, entertainment, informative, and expressive. When taking Instagram posts at face value (i.e., not accounting for sarcasm, lying), these labels are capable of describing any post that might appear. The labels seek to describe the intended rhetorical effect of the visual semantic media, but are perlocutionary insofar as intent is described by purposefully ignoring sarcasm/malice that may have been intended.

The advocative label describes posts that advocate for any figure, idea, movement, etc. This can be in the form of political advocacy, social advocacy, or cultural/religious advocacy. The promotive label describes posts with the primary intent to promote. This can be by promoting events, promoting products, or promoting organizations. The exhibitionist label describes posts that seek to create a self-image for the user. This can be in terms of selfies, pictures of belongings, events attended, and any other content that is used to instantiate/modify others perception of oneself. The expressive label describes posts that express emotion, attachment, or admiration at an external entity or group. It is distinguished from the exhibitionist label by its focus on the external as opposed to the self. Expressive posts can express love, respect, loss, appreciation for family, and other forms of primarily expressive intent.

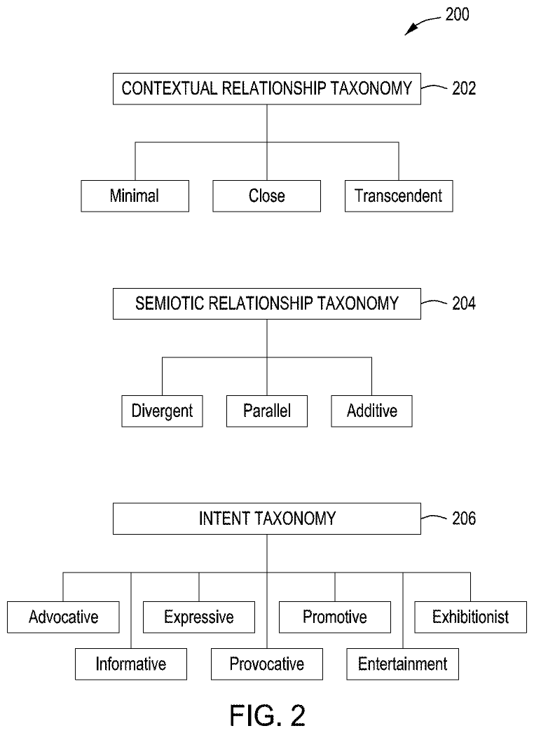

The informative label describes posts that relay information regarding a subject or event. They are characterized by factual, non-rhetorical language. They may relay information about history, news, or science. The entertainment label describes posts of which the primary intent is to entertain. This can be art, humor, memes, or various other visual stimuli meant only to divert. The provocative label is split up into two sub-labels, the discriminative and the controversial. The discriminative sub-label describes content that directly targets an individual or group. It may be racist, misogynist, or otherwise generally derogatory, and it is always an attack. The controversial sub-label describes broadly content that would be seen as shocking to the general public, but without any single target. It may be disturbing aesthetically or in terms of content, or it may be representative of a lifestyle deemed unacceptable to mass society. Generally, it describes content that intends to either challenge the audience or make the audience uncomfortable. This category relies more heavily than others on a socio-cultural response, but since it is an important formal category, and since the entire intent of this category is indeed to provoke such a response, this was an acceptable deviation from the standard methodology. All three taxonomies 202, 204, 206 are illustrated in a view 200 of FIG. 2.

In one example, data is collected and structured based on the intent taxonomy. For each heading (e.g., advocative, promotive, exhibitionist, etc.), at least 16 hashtags or users were collected that would be likely to yield a high proportion of Instagram posts that could be labeled by that heading. For example, under advocative, # pride, # maga were among the hashtags. For this example, not only were all of the intent categories populated, but they also each held a diverse set of data. The interest is in determining intent through the underlying features of the image/caption pair. Too great a concentration of one expression of that intent would cause the intent to be recognized solely as the particular aspects of that expression.

For advocative data, mostly hashtags advocating some sort of political or social ideology were selected. This ranged from right-wing politics to posts about the New York Pride Parade. For promotive data, sufficient data was able to be collected as Instagram has recently begun requiring # ad to be included with all sponsored posts. Tags such as # joinus were used to obtain promotive data relating to events rather than products. For exhibitionist data, tags such as # selfie and # ootd (outfit of the day) proved consistent. Any tags that focused on the self as the most important aspect of the post would usually yield exhibitionist data. The expressive data set comprised primarily of tags that actively expressed something. Examples are # lovehim or # merrychristmas. For informative data, accounts that made informative posts such as news websites were used. The entertainment category was made up of an eclectic groups of tags and posts e.g. # meme, # earthporn, # fatalframes. The provocative category was made up of tags that either expressed the message of the poster or that would draw people into be influenced or provoked by the post (# redpill, # antifa, # eattherich, # snowflake).

The data for labeling was first prepared with some preprocessing. Instagram posts can either contain one image or multiple images compiled into albums. Albums were not used as part of the dataset, and the albums were converted into single posts. A simple annotation toolkit was made that displayed an image-caption pair and queried the user as to whether the data was acceptable. If the data was acceptable, it queried the user as to the post's intent (advocative, promotive, exhibitionist, expressive, informative, entertainment, provocative), its contextual relationship (minimal, close, transcendent), and its semiotic relationship (divergent, parallel, additive). Once a single round of annotation was finished, the results were written in a JSON (JavaScript Object Notation) file to the disk.

In order to verify the correctness and applicability of the dataset and meaning multiplication, a machine learning based model is trained and tested on the collected dataset. A model based on deep convolutional neural networks (DCNN) is implemented that can work with either image (Img) or text modality (Txt) or both (Img+Txt). The DCNN based model consists of modality specific encoders, a fusion layer, and a class prediction layer. A pre-trained CNN such as, for example, ResNet-18, that is pre-trained on ImageNet is used as the image encoder. For encoding captions, a standard pipeline is used that employs a Recurrent Neural Network (RNN) model on word embeddings. For word embeddings, (pre-trained) ELMo embeddings (see, M. E. Peters, M. Neumann, M. Iyyer, M. Gardner, C. Clark, K. Lee, and L. Zettlemoyer. Deep contextualized word representations. arXiv preprint arXiv:1802.05365, 2018) and standard word (token) embeddings (trained from scratch) (see, T. Mikolov, I. Sutskever, K. Chen, G. S. Corrado, and J. Dean. Distributed representations of words and phrases and their compositionality. In Advances in neural information processing systems, pages 3111-3119, 2013) can be used.

In comparison to standard word embedding such as word2vec, ELMo (word) embeddings have been shown to be superior as they are enriched with context by using a bi-directional language model. Moreover, these word embeddings are built on top of character embeddings which makes them robust to encode (noisy) captions from Instagram that often contain spelling mistakes. For the combined model, a simple fusion strategy is implemented that first projects encoded vectors from both the modalities in the same embedding space by using a linear projection and then adds the two vectors. This naive fusion strategy has recently been shown to be quite effective at different tasks such as Visual Question Answering (see, D. K. Nguyen and T. Okatani. Improved fusion of visual and language representations by dense symmetric co-attention for visual question answering. arXiv preprint arXiv:1804.00775, 2018) and image-caption matching (see, K. Ahuja, K. Sikka, A. Roy, and A. Divakaran. Understanding visual ads by aligning symbols and objects using co-attention. arXiv preprint arXiv:1807.01448, 2018). The fused vector is then used to predict class-wise scores using a fully connected layer.

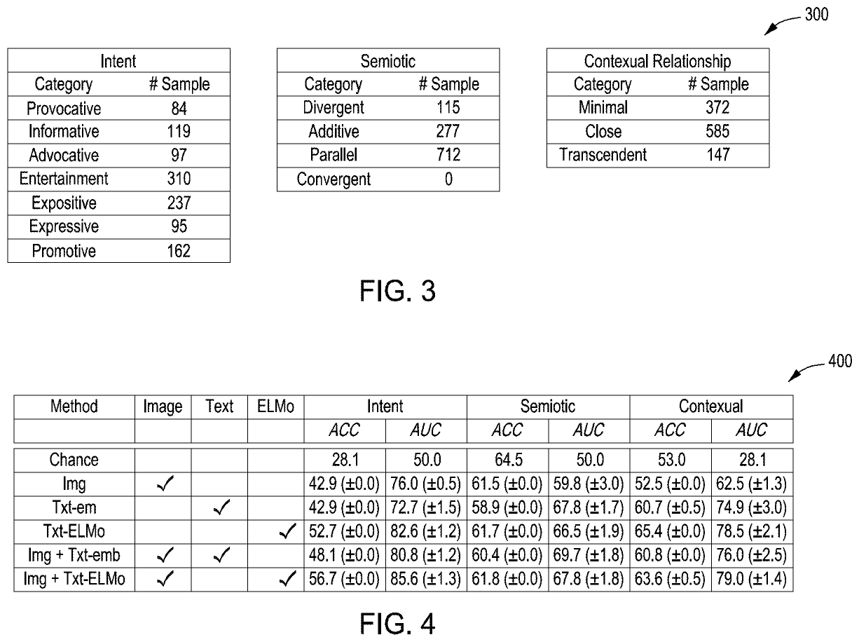

The ability of machine learning based models were evaluated based on the task of predicting intent, semiotic relationships, and image-text relationships from Instagram posts. In particular, three models were evaluated based on using visual modality, textual modality, and finally both modalities. The dataset used for the evaluations along with the experimental protocol and evaluation metrics are first described followed by implementation details and quantitative results. For evaluation, the dataset collected (as described above) is used. This dataset is referred to as the Instagram-Intent Data, which has 1299 samples. Only corresponding image and text information is used for each post and other meta-data such as hashtags is not used for the evaluations. Basic pre-processing is performed on the captions such as removing stopwords and non-alphanumeric characters. No pre-processing is performed for images. The distribution of classes is highly skewed across the three taxonomies as shown in a view 300 of FIG. 3.

For implementation of some embodiments, a pre-trained ResNet-18 model is used as the image encoder. For word token based embeddings, 300 dimensional vectors are used that are trained from scratch. For ELMo, a publically available application programming interface (API) (see, https://github.com/allenai/allennlp/blob/master/tutorials/how_to/elmo.md) is used and two layers from pre-trained models are used resulting in 2048 dimensional input. A bidirectional gated recurrent unit (GRU) is used as the RNN model with 256 dimensional hidden layers. The dimensionality of the common embedding space is set in the fusion later to 128. In the case of a single modality, the fusion layer only projects features from that modality. Adam optimizer is used for training the model with a learning rate of 0:00005, which is decayed by 0:1 after every 15 epochs. Results with the best model selected based on performance on a mini validation set are reported. The results of different models are shown in a view 400 of FIG. 4.

In FIG. 4, the Img refers to image-only model, Txt-emb refers to text-only model with word vectors (trained from scratch), Txt-ELMo refers to text-only model with ELMo word vectors, I+Txt-emb and I+Txt-ELMo refers to the joint image-text model with word vectors and ELMo based word vectors, respectively. For the intent taxonomy, the performance of the image-only model was observed by the inventors to be better than the text-only model (76% of Img vs 72.7% of Txt-emb). However, the performance of text-only model improves considerably when using ELMo based word vectors and even outperforms Img (82.6% of Txt-ELMo vs. 76.0% of Img). This improvement may be due to the strength of ELMo based word embeddings that encode context and the fact that it is built over a language model pre-trained over a large corpus. Similar improvements were also observed when using Elmo based embedding for contextual taxonomy but not for semiotic taxonomy.

In the case of semiotic taxonomy, the inventors observed that the word based embeddings had similar performance to ELMo based embeddings (67.8% of Txt-emb vs. 66.5% of Txt-ELMo). For the semiotic taxonomy, the model may be able to make the right prediction with the presence of specific words instead of using the entire sentence. In the case of the joint model using both visual and textual modalities, improvements were observed across all taxonomies and types of word vectors. For example, the joint model Img+Txt-ELMo has a performance of 85.6% for the intent taxonomy versus 82.6% of Txt-ELMo and 76.0% of Img. The improvement is significant when using standard word embedding (80.8% of Img+Txt-emb vs. 72.7% of Txt-emb). Improvements were also observed for image-text relationship and semiotic taxonomy with the joint model compared to their single modality counterparts. These improvements highlight the occurrence of meaning multiplication—verified by the evaluation results.

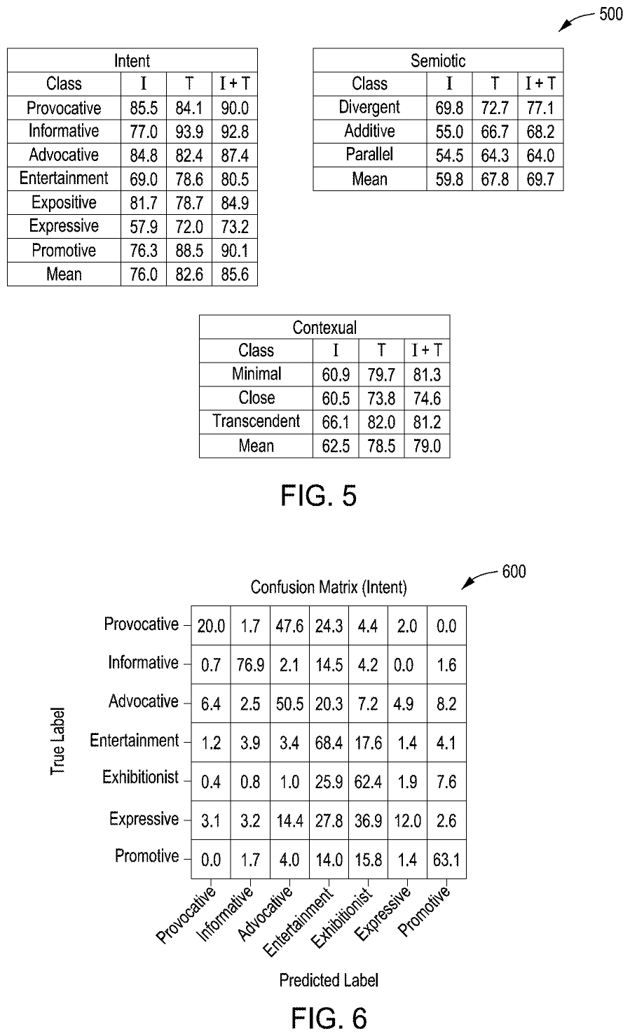

Class-wise performances with the single modality and multi-modality model are shown in a view 500 of FIG. 5. With the semiotic taxonomy, the maximum gain in accuracy with multimodality is achieved with divergent semiotics (gain of 4.4% compared to the image-only model) followed by additive semiotics (gain of: 5% compared to the image-only model) which especially reinforces the notion of meaning multiplication. With parallel semiotics, the image and the text convey similar meaning, so there is not as much gain with multimodality. Particularly, the effectiveness of the joint multimodal model shows that social-media users use both image and text to effectively convey their intent.

The evaluation results show that there is a marked increase in the accuracy of prediction when image and text are analyzed together. The evaluation results observed by the inventors demonstrate that multimodality should not only be treated as a linear addition of meaning, but instead with the consideration of a multiplicative creation of meaning. This is clear when analyzing the results of the three semiotic categories. Where the image and text are parallel there is little increase in accuracy when the two are combined. As both point to the same idea, they may be analyzed in isolation without much loss of meaning. There is an accuracy increase when text and image with an additive relationship are analyzed together. The highest gain in accuracy of prediction is not additive, it is divergent. When the signs of the image and the text do not combine to add information to each other, but instead have totally separate meanings, that is where, by a large margin, the model makes its highest gains in terms of accuracy. A similar gain happens within the informational relationships. That is, the “minimal” category makes the most gains when image and text are combined. When the information present in these two modes does not overlap, that is when meaning is most easily discovered by the model. On, for example, Instagram, image and caption do not only reflect each other: they diverge, and through their divergence the signs and information of the image and text are multiplied against each other, and new, strikingly identifiable meanings are formed.

A confusion matrix illustrated in a view 600 of FIG. 6 makes clear some of the finer points of this new form of meaning making. The least confused category is informative, and when it is viewed in terms of the other categories, the reasons behind this become clear. Informative posts are the ones least like the rest of Instagram. The category is made up of detached, objective posts, without much use of “I” or “me.” The poster is least present in these posts. Informative posts function closest to the traditional conception of image/caption pairs, thus very easy to distinguish in this new setting. The promotive posts are next in terms of accurate prediction. They, like informative, posts mainly intend to inform the viewer as to the advantages and practical details of an item or event. Unlike informative posts, however, they are more likely to contain the personal opinions of the poster. For example, “I love this watch” or “This event is very important to me.” The promotive post is formally informative, but its intent is inherently persuasive.

Posts that have been determined to belong to the category “entertainment” are most commonly predicted as such. With their often extreme divergence, they rarely fall into any other category. However, “entertainment” is the most commonly misapplied label. This speaks to the heart of the problem of Instagram, and to one of the main issues within contemporary social media semiotics: all posts are entertainment. No matter the intent of the poster, the reason why an individual scrolls through Instagram is, by and large, to be entertained. “Exhibitionist” tends to be predicted well, likely due to its visual and textual signifiers of individuality (e.g., the selfie is almost always exhibitionist, as are captions like “I love my new hair”). There is a great deal of confusion, however, between the expressive and exhibitionist categories. Expressive is poorly predicted, and more often than not labeled as exhibitionist. As noted above, the difference between these two categories is the point of focus, that is, whether the post is about the poster, or about another person/event/object. While this distinction is simple for a human to make, that both categories' primary feature is personal expression complicates the task for machine learning. There is a bidirectional confusion in terms of the provocative and advocative categories. As provocative posts often seek to prove points in a similar way to advocative posts, this confusion is unsurprising. Formally, provocative posts often resemble entertainment posts (memes, etc.), and this is reflected in the high percentage of provocative posts mislabeled as entertainment posts.

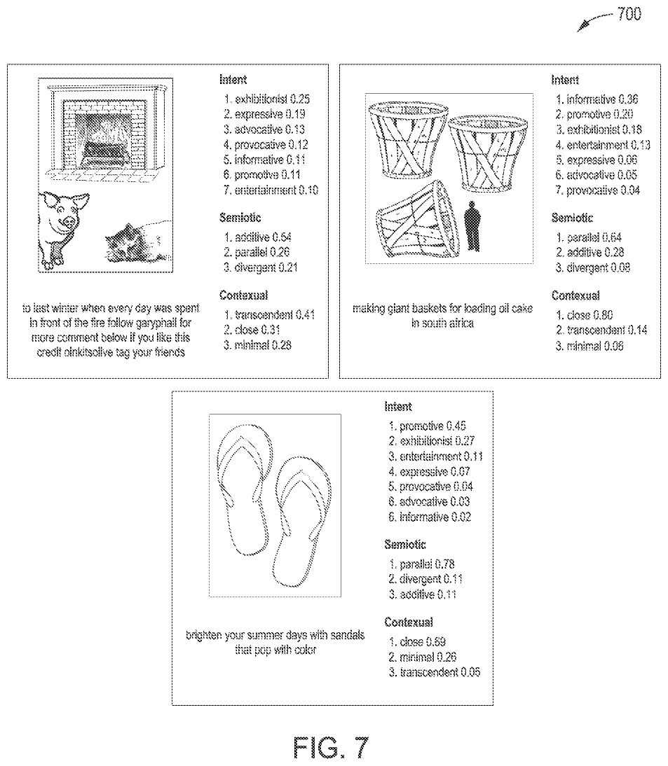

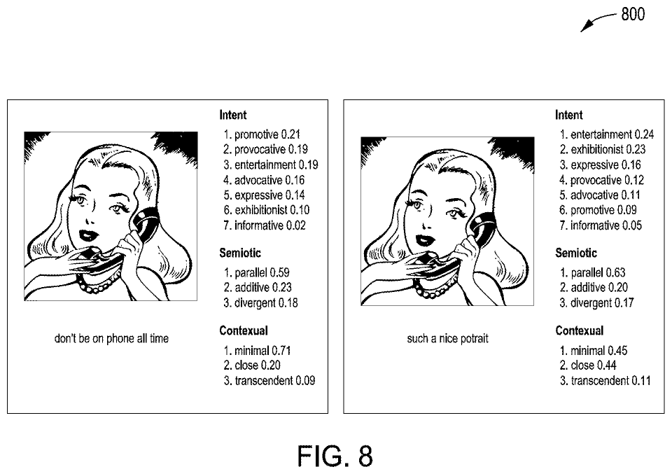

Output prediction of the multimodal model is illustrated for several examples in a view 700 of FIG. 7 and in a view 800 of FIG. 8. While the examples of FIG. 7 show the efficacy of the classification, they do not include examples in which the semiotic relationship between the caption and the image is divergent. Note that while such divergence produces very interesting and often widely shared posts, those constitute a tiny minority. The majority of posts have a parallel semiotic relationship between the caption and the image, and do not make much use of meaning multiplication. In other words, FIG. 7 is representative of typical Instagram posts. To further bring out the significance of meaning multiplication, consider what happens when the same image is matched with two different captions as shown in FIG. 8. The change in the caption leads to a completely different intent as well as semiotic and contextual relationships, which is consistent with the notion of meaning multiplication.

In FIG. 8, the image-caption pair at left, with the caption “don't be on phone all the time” is classified as having a promotive intent because it is perceived as pushing phones by the classifier. The semiotic relationship is classified as parallel because both the image and the caption are signifying phone conversations. Given that the overlap in meaning is low, the contextual relationship is classified as minimal. However, when the caption is changed to “such a nice portrait” the intent is now classified as entertainment with exhibitionist as a close second. The semiotic relationship is still classified as parallel because of the common theme of signifying people in the image and the caption, and the contextual relationship is still classified as minimal because of the image and caption hardly overlap. The same caption has been used and the associated images have been changed, yielding very similar results. FIG. 8, thus, shows how the same image can convey a completely different intent when paired with a different caption as mentioned earlier. Note that image-caption pairs sometimes straddle two or even three categories. The intent classification results may be captured as a vector of class probabilities for that reason.

The methods of the present principles may also include embodiments that may extract information to aid in measuring if one or more agent(s)/user(s) are closer to reaching a goal based on an intended result of a posting. This information could be used, for example, to determine which advertiser does a more effective job for a given client. The methods of the present principles may also include embodiments that may extract information to determine if an agent or user is diverging from a goal and direct them on how to better achieve that goal. For example, if the agent/user is attempting to influence people to buy more toothbrushes or to brush more often, the model can extract data and determine if the postings are actually more or less effective than intended and give information on how to adjust their effectiveness. This is especially useful for advertisers to distinguish between visible intent and actual consumer perceived intent. Similarly, information may be extracted from the methods of the present principles to provide dialog management (e.g., to ensure proper intent is being conveyed) and/or for better understanding of context. An agent may be a person or bot and the like who/which posts content.

The inventors have introduced the notion of document intent, stemming from a desire to influence, in Instagram posts—data which mostly consists of image-caption pairs which makes them inherently multimodal. As shown in the evaluation examples, the meaning of social media posts, such as an Instagram post, is the result of meaning multiplication between the image and the caption. Thus, the image and caption combine to create a meaning that is more than the sum of the individual semiotic analysis of the caption and image. The inventors have adopted taxonomies for pre-social-media content to propose an intent taxonomy as well as two related taxonomies for the contextual and semiotic relationships of the image-caption pair. The contextual relationship describes the overlap in meaning, while the semiotic relationship indicates the alignment in what is being signified or symbolized by each modality. A dataset was collected consisting of 1299 image-caption pairs covering all the possibilities in the three taxonomies. The deep learning models of the present principles were trained with this dataset and show that multimodal classification gives consistent gains over using just one of the modalities over all three taxonomies with an 8% increase in intent detection. Specifically, the inventors have discovered that that the maximum gain in the detection of semiotics is with divergent semiotics, which verifies that there is meaning multiplication between images and captions.

In the foregoing description, numerous specific details, examples, and scenarios are set forth in order to provide a more thorough understanding of the present principles. It will be appreciated, however, that embodiments of the principles can be practiced without such specific details. Further, such examples and scenarios are provided for illustration, and are not intended to limit the teachings in any way. Those of ordinary skill in the art, with the included descriptions, should be able to implement appropriate functionality without undue experimentation. References in the specification to “an embodiment,” etc., indicate that the embodiment described may include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated. Embodiments in accordance with the teachings can be implemented in hardware, firmware, software, or any combination thereof. Embodiments may also be implemented as instructions stored using one or more machine-readable media, which may be read and executed by one or more processors.

A machine-readable medium may include any mechanism for storing or transmitting information in a form readable by a machine (e.g., a computing device or a “‘virtual machine” running on one or more computing devices). For example, a machine-readable medium may include any suitable form of volatile or non-volatile memory. Modules, data structures, blocks, and the like are referred to as such for case of discussion, and are not intended to imply that any specific implementation details are required. For example, any of the described modules and/or data structures may be combined or divided into sub-modules, sub-processes or other units of computer code or data as may be required by a particular design or implementation. Further, references herein to rules or templates are not meant to imply any specific implementation details. That is, the multimodal content embedding systems can store rules, templates, etc. in any suitable machine-readable format.

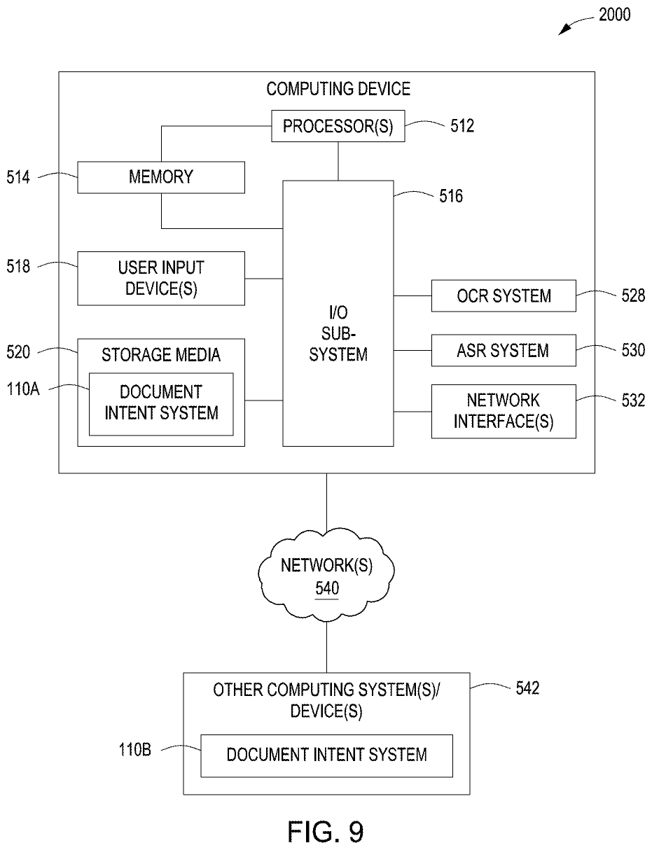

Referring to FIG. 9, a simplified high level block diagram of an embodiment of the computing device 900 in which a document intent system can be implemented is shown. While the computing device 900 is shown as involving multiple components and devices, it should be understood that in some embodiments, the computing device 900 can constitute a single computing device (e.g., a mobile electronic device, laptop or desktop computer) alone or in combination with other devices. The illustrative computing device 900 can be in communication with one or more other computing systems or devices 542 via one or more networks 540. In the embodiment of FIG. 9, illustratively, a portion 110A of the document intent system can be local to the computing device 510, while another portion 1106 can be distributed across one or more other computing systems or devices 542 that are connected to the network(s) 540.

In some embodiments, portions of the document intent system can be incorporated into other systems or interactive software applications. Such applications or systems can include, for example, operating systems, middleware or framework software, and/or applications software. For example, portions of the document intent system can be incorporated into or accessed by other, more generalized system(s) or intelligent assistance applications. The illustrative computing device 900 of FIG. 9 includes at least one processor 512 (e.g. a microprocessor, microcontroller, digital signal processor, etc.), memory 514, and an input/output (I/O) subsystem 516. The computing device 900 can be embodied as any type of computing device such as a personal computer (e.g., desktop, laptop, tablet, smart phone, body-mounted device, etc.), a server, an enterprise computer system, a network of computers, a combination of computers and other electronic devices, or other electronic devices.

Although not specifically shown, it should be understood that the I/O subsystem 516 typically includes, among other things, an I/O controller, a memory controller, and one or more I/O ports. The processor 512 and the I/O subsystem 516 are communicatively coupled to the memory 514. The memory 514 can be embodied as any type of suitable computer memory device (e.g., volatile memory such as various forms of random access memory). In the embodiment of FIG. 9, the I/O subsystem 516 is communicatively coupled to a number of hardware components and/or other computing systems including one or more user input devices 518 (e.g., a touchscreen, keyboard, virtual keypad, microphone, etc.), and one or more storage media 520. The storage media 520 may include one or more hard drives or other suitable data storage devices (e.g., flash memory, memory cards, memory sticks, and/or others).

In some embodiments, portions of systems software (e.g., an operating system, etc.), framework/middleware (e.g., application-programming interfaces, object libraries, etc.), the document intent system resides at least temporarily in the storage media 520. Portions of systems software, framework/middleware, the document intent system can also exist in the memory 514 during operation of the computing device 900, for faster processing or other reasons. The one or more network interfaces 532 can communicatively couple the computing device 900 to a local area network, wide area network, a personal cloud, enterprise cloud, public cloud, and/or the Internet, for example. Accordingly, the network interfaces 532 can include one or more wired or wireless network interface cards or adapters, for example, as may be needed pursuant to the specifications and/or design of the particular computing device 900. The other computing device(s) 542 can be embodied as any suitable type of computing device such as any of the aforementioned types of devices or other electronic devices. For example, in some embodiments, the other computing devices 542 can include one or more server computers used with the document intent system.

The computing device 900 can further optionally include an optical character recognition (OCR) system 528 and an automated speech recognition (ASR) system 530. It should be understood that each of the foregoing components and/or systems can be integrated with the computing device 900 or can be a separate component or system that is in communication with the I/O subsystem 516 (e.g., over a network). The computing device 900 can include other components, subcomponents, and devices not illustrated in FIG. 9 for clarity of the description. In general, the components of the computing device 900 are communicatively coupled as shown in FIG. 9 by signal paths, which may be embodied as any type of wired or wireless signal paths capable of facilitating communication between the respective devices and components.

In the drawings, specific arrangements or orderings of schematic elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application-programming interface (API), and/or other software development tools or frameworks. Similarly, schematic elements used to represent data or information may be implemented using any suitable electronic arrangement or data structure. Further, some connections, relationships or associations between elements may be simplified or not shown in the drawings so as not to obscure the teachings herein. While the foregoing is directed to embodiments in accordance with the present principles, other and further embodiments in accordance with the principles described herein may be devised without departing from the basic scope thereof, and the scope thereof is determined by the claims that follow.

1. A method of creating a semantic embedding space for multimodal content for determining intent of content, the method comprising:
for each of a plurality of content of the multimodal content, creating a respective, first modality feature vector representative of content of the multimodal content having a first modality using a first machine learning model;
for each of a plurality of content of the multimodal content, creating a respective, second modality feature vector representative of content of the multimodal content having a second modality using a second machine learning model;
for each of a plurality of first modality feature vector and second modality feature vector multimodal content pairs, forming a combined multimodal feature vector from the first modality feature vector and the second modality feature vector;
for at least one first modality feature vector and second modality feature vector multimodal content pair, assigning at least one taxonomy class of intent; and
semantically embedding the respective, combined multimodal feature vectors in a common geometric space, wherein embedded combined multimodal feature vectors having related intent are closer together in the common geometric space than unrelated multimodal feature vectors.

2. The method of claim 1, wherein semantically embedding multimodal content into the common geometric space comprises:
projecting a multimodal feature vector representing a first modality feature of the multimodal content and a second modality feature of the multimodal content into the common geometric space; and
inferring an intent of the multimodal content mapped into the common geometric space based on a proximity of the mapped multimodal content to at least one other mapped multimodal content in the common geometric space having a predetermined intent such that determined related intents between multimodal content result in an improvement in recognition of influential impact of the multimodal content.

3. The method of claim 2, wherein the multimodal content is a social media posting.

4. The method of claim 2, further comprising:
determining if a first multimodal content is in proximity to a desired intent.

5. The method of claim 4, further comprising:
suggesting alterations of the first multimodal content such that the altered first multimodal content, if mapped to the common geometric space, would be closer to the desired intent.

6. The method of claim 1, wherein intent is classified by a taxonomy comprising advocative, information, expressive, provocative, entertainment, and exhibitionist classes.

7. The method of claim 1, further comprising:
determining a contextual relationship between a first modality feature represented by the first modality feature vector of the multimodal content and a second modality feature represented by the second modality feature vector of the multimodal content.

8. The method of claim 7, wherein the contextual relationship is classified by a taxonomy comprising minimal, close, and transcendent classes.

9. The method of claim 1, further comprising:
inferring a semiotic relationship between a first modality represented by the first modality feature vector of the multimodal content and a second modality represented by the second modality feature vector of the multimodal content.

10. The method of claim 9, wherein the semiotic relationship is classified by a taxonomy comprising divergent, parallel, and additive classes.

11. The method of claim 1, wherein the common geometric space is a non-Euclidean common geometric space.

12. The method of claim 1, further comprising:
semantically embedding the respective, combined multimodal feature vectors including the respective at least one taxonomy class of intent in a common geometric space.

13. A method of creating a semantic embedding space for multimodal content for determining intent of content, the method comprising:
for each of a plurality of content of the multimodal content, creating a respective, first modality feature vector representative of content of the multimodal content having a first modality using a first machine learning model;
for each of a plurality of content of the multimodal content, creating a respective, second modality feature vector representative of content of the multimodal content having a second modality using a second machine learning model;
for each of a plurality of first modality feature vector and second modality feature vector multimodal content pairs, forming a combined multimodal feature vector from the first modality feature vector and the second modality feature vector;
for at least one first modality feature vector and second modality feature vector multimodal content pair, assigning at least one taxonomy class of intent;
projecting the combined multimodal feature vector into the common geometric space; and
inferring an intent of the multimodal content represented by the combined multimodal feature vector based on the projection of the multimodal feature vector in the common geometric space and a classifier.

14. The method of claim 13, further comprising:
determining if a first multimodal content associated with a first agent is in proximity to a desired intent; and
suggesting alterations of the first multimodal content to the first agent such that the first multimodal content will be mapped into the common geometric space closer to the desired intent.

15. The method of claim 13, further comprising:
inferring a semiotic relationship between a first modality represented by the first modality feature vector of the multimodal content and a second modality represented by the second modality feature vector of the multimodal content.

16. The method of claim 13, wherein intent is classified by the classifier based on a taxonomy comprising advocative, information, expressive, provocative, entertainment, and exhibitionist classes.

17. A non-transitory computer-readable medium having stored thereon at least one program, the at least one program including instructions which, when executed by a processor, cause the processor to perform a method of creating a semantic embedding space for multimodal content for determining intent of content, comprising:
for each of a plurality of content of the multimodal content, creating a respective, first modality feature vector representative of content of the multimodal content having a first modality using a first machine learning model;
for each of a plurality of content of the multimodal content, creating a respective, second modality feature vector representative of content of the multimodal content having a second modality using a second machine learning model;
for each of a plurality of first modality feature vector and second modality feature vector multimodal content pairs, forming a combined multimodal feature vector from the first modality feature vector and the second modality feature vector;
for at least one first modality feature vector and second modality feature vector multimodal content pair, assigning at least one taxonomy class of intent; and
semantically embedding the respective, combined multimodal feature vectors in a common geometric space, wherein embedded combined multimodal feature vectors having related intent are closer together in the common geometric space than unrelated multimodal feature vectors.

18. The non-transitory computer-readable medium of claim 17, further comprising:
determining if a first multimodal content associated with a first agent is in proximity to a desired intent; and
suggesting alterations of the first multimodal content to the first agent such that the first multimodal content will be mapped into the common geometric space closer to the desired intent.

19. The non-transitory computer-readable medium of claim 17, further comprising:
inferring a semiotic relationship between a first modality represented by the first modality feature vector of the multimodal content and a second modality represented by the second modality feature vector of the multimodal content.

20. The method of claim 19, wherein the semiotic relationship is classified by a taxonomy comprising divergent, parallel, and additive classes.
